(19) United States
(12) Patent Application Publication
(10) Pub. No.: US 2012/0170474 A1
(43) Pub. Date: Jul. 5, 2012

(54) System and Method of Adaptive Roaming for WLAN Clients

(75) Inventor: Matthew R. Pekarske, Milwaukee, WI (US)

(73) Assignee: GENERAL ELECTRIC COMPANY, Schenectady, NY (US)

(21) Appl. No.: 12/984,272

(22) Filed: Jan. 4, 2011

(51) Int. Cl. H04W 36/30

(52) U.S. Cl. 370/252

(57) ABSTRACT

The system and method of the present application improves the performance of a WLAN client by sensing the environment and dynamically adjusting roam trigger values. The system and method scans the WLAN area for access points (AP) and analyzes the signal quality of an AP based on a plurality of AP system parameters. If signal quality of the current AP is less than that of the AP that was scanned, then the WLAN card enters into a roaming mode in order to connect with the higher signal quality AP. If the signal of the current AP is greater, then a new scan is conducted after a predetermined amount of time.

### FIELD

The present application is directed to the field of wireless patient monitoring systems. More specifically, the present application is directed to the field of original equipment manufacturer (OEM) cards effectuating wireless roaming in WLAN clients.

### BACKGROUND

In current systems, WLAN Clients make roaming decisions based on a comparison of measured environmental data to hard-coded values. Roaming occurs when the device determines that an access point (AP) that it is connected to is no longer of significant quality, and as such searches the network for another AP to connect to. In these systems, a WLAN client roams solely based on signal strength, so impacts from wireless environmental effects like interference (both broadband and narrowband) are not taken into account. Additionally, during network congestion associated with a large number of other clients connected to the same access point (AP) as the given client, all clients are competing for channel access on the same AP which reduces the overall throughput.

In current systems, several APs are installed and active in a particular wireless environment. The device looking to connect to an AP in close proximity would do so, and as that device was moved throughout the wireless network, and the signal strengths of the AP connection decreased the wireless device would look for another AP with a stronger signal strength, and connect to that AP. A wireless device can partake in roaming for a new AP when the wireless device is moving throughout the wireless network or when it is stationary, and some physical part of the wireless environment obstructs the connection between the wireless device and the AP, e.g., a door is closed, equipment is moved, or some other obstruction is made between the AP and the device.

Typically, in order to enter a roaming mode, the wireless device needs to determine that a change in the environment has occurred. Accordingly, such current devices monitor the environment and compare the values that it has recorded from the environment to a trigger point. If the trigger point is exceeded, then the wireless device enters into a roaming mode. If no trigger point is exceeded, then the wireless device stays connected to its current AP. These trigger points are typically hardcoded into the WLAN card, and are not adjustable. Accordingly, in typical systems, the wireless device usually only enters into a roaming mode when its current signal strength drops below a predetermined level.

### SUMMARY

The system and method of the present application improves the performance of a WLAN client by sensing the environment and dynamically adjusting roam trigger values. The system and method scans the WLAN area for access points (AP) and analyzes the signal quality of an AP based on a plurality of AP system parameters. If signal quality of the current AP is less than that of the AP that was scanned, then the WLAN card enters into a roaming mode in order to connect with the higher signal quality AP. If the signal of the current AP is greater, then a new scan is conducted after a predetermined amount of time.

In one aspect of the present application, a wireless patient monitoring system comprises a plurality of wireless access points dispersed throughout a monitoring area, wherein the plurality of access points are connected together through a network, and a patient monitor including a WLAN wireless card, wherein the WLAN wireless card wirelessly connects the patient monitor to a first wireless access point of the plurality of wireless access points, wherein the WLAN wireless card scans the monitoring area and performs a signal quality analyses on the plurality of access points, and further wherein the WLAN wireless card goes into a roam mode when a signal quality of the first wireless access point is less than the signal quality of any of the analyzed plurality of access points.

In another aspect of the present application, a method of adaptive roaming in a wireless patient monitoring system comprises executing a set of executable code stored in a storage medium with a processor, thus effectuating the following steps: wirelessly connecting a patient monitor with a WLAN wireless card to a first wireless access point of a plurality of wireless access points dispersed throughout a monitoring area, wherein the plurality of access points are connected together through a network, scanning with the WLAN wireless card the monitoring area, performing a signal quality analyses on the plurality of access points, and entering a roam mode with the WLAN wireless card when a signal quality of the first wireless access point is less than the signal quality of any of the analyzed plurality of access points.

### BRIEF DESCRIPTION OF THE FIGURES

FIG. 1 is a flowchart illustrating an embodiment of a method of the present application.

FIG. 2 is a flowchart illustrating an embodiment of a method of the present application.

FIG. 3 is a schematic block diagram illustrating an embodiment of a system of the present application.

### DETAILED DESCRIPTION

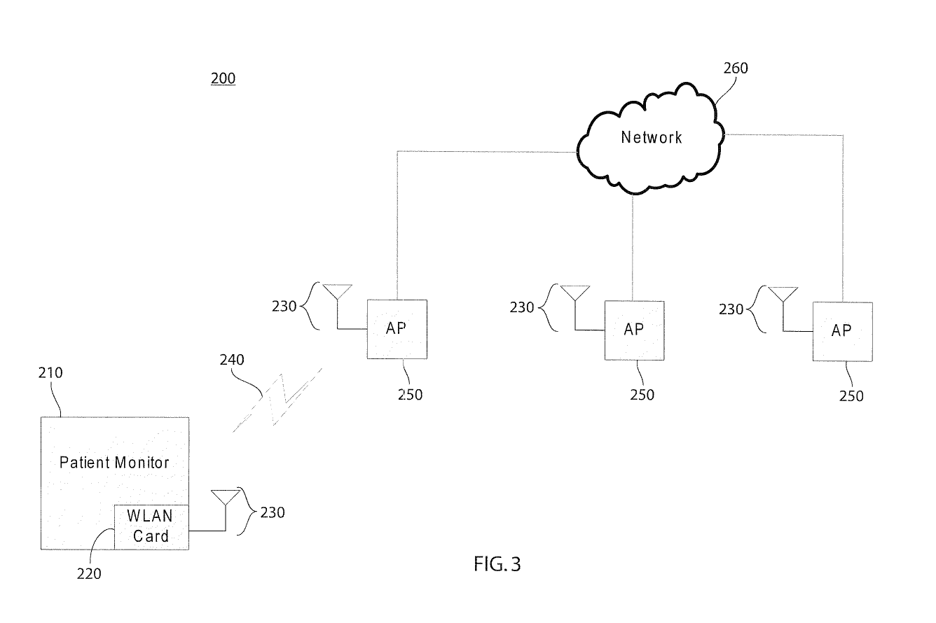

Referring first to FIG. 3, a system block diagram according to one embodiment of the present application is illustrated. Here, the system 200 includes a patient monitor 210 having a WLAN wireless card 220 and a transmitter 230. The plurality of access points 250, each having a transceiver 230 are dispersed throughout the wireless network, and are connected through a network 260.

Still referring to FIG. 3, the patient monitor 210 can be any known or future patient monitoring device that has wireless monitoring capabilities. Such current examples of a patient monitor 210 of the present application include without limitation: the CARESCAPE Dash and B650 Patient Monitor. In one embodiment, the WLAN card 220 is an original equipment manufacturer (OEM) card, and in an embodiment includes a storage medium having computer executable code, and a processor to execute that code, thus effectuating the operation of the WLAN card 220. In further embodiments, the patient monitor 210 will include a storage medium and processor (not shown) for effectuating the operation of the patient monitor 210 and the WLAN card 220. Additional embodiments of the system 200 may also operate without a separate WLAN card 220 to effectuate the wireless operation of the system, but will have the hardwired circuitry and executable code of the WLAN card 220 incorporated directly into the patient monitor 210.

Still referring to FIG. 3, the patient monitor 210 communicates through wireless transmission 240 utilizing a transceiver 230 with a plurality of access points (AP) 250, the APs each having a transceiver 230. The plurality of access points 250 are connected through a network 260. The network 260 may be one normally employed to connect a number of access points 250 in such a system 200. A typical wireless system 200 includes a plurality of the access points 250 specifically configured throughout the area of the system 200, monitoring a number of patient monitors 210, also configured throughout the wireless system 200 by being placed in proximity to a patient being monitored. The network 260 receives wirelessly transmitted information from the access points 250, and relays the information collected from the access points 250 to a hospital information system suitable for collecting and managing such information. Such hospital information systems are well known in the art, and the present system utilizes those known in the art, and is capable of adapting to new hospital information systems developed at a later time.

In operation, the system 200 of FIG. 3 of the present application includes a patient monitor 210 that is communicating through wireless transmission 240 to a first one of the access points 250, thus relaying any physiological information collected by the patient monitor 210 through the access point 250 and to the network 260. The system 200 utilizes the WLAN card 220 and the transceivers 230 associated with the patient monitor 210 and the access point 250 to facilitate the wireless transmission 240 of the physiological data.

Once the patient monitor 210 is in wireless transmission 240 (or connected to) a first access point 250, the WLAN card 220 conducts a scan of the system 200 to see if any other of the access points 250 may have a better signal quality than the first access point 250 that the patient monitor 210 is currently in communication with. As stated above in the Background section, current systems ordinarily only take into account the signal strength of the access points 250 in determining whether to enter into a roaming mode, thus allowing the patient monitor 210 to connect with a second access point 250 and drop the first access point 250. However, in the system 200 of the present application, a signal quality analysis is conducted on the other access points utilizing and considering a received signal strength indicator (RSSI), a signal to noise ratio, the number of clients attached to a given access point, data retries in a given time period for the WLAN card, a number of expected beacons not received in a given time period for the WLAN card, a current data rate for each access point, and a time since the last scan of the access points. These parameters are utilized to determine the signal quality of other access points, utilizing a predetermined algorithm that will be discussed in more detail below.

The signal quality of the first access point 250 that is currently connected with the patient monitor 210 is compared to the signal quality for the access points 250 from the pre-mentioned scan. If the signal quality of the first access point 250 is greater than those collected from the scan and signal quality analysis, then the system waits a predetermined amount of time before conducting another scan. If however, the signal quality of the first access point 250 is less than any of the access points analyzed during the scan, then the WLAN card 220 enters a roaming mode, and connects to a second access point 250 having the best signal quality according to the scan and analysis. This operation is repeated within the system 200 to ensure the highest quality signal for each patient monitor 210.

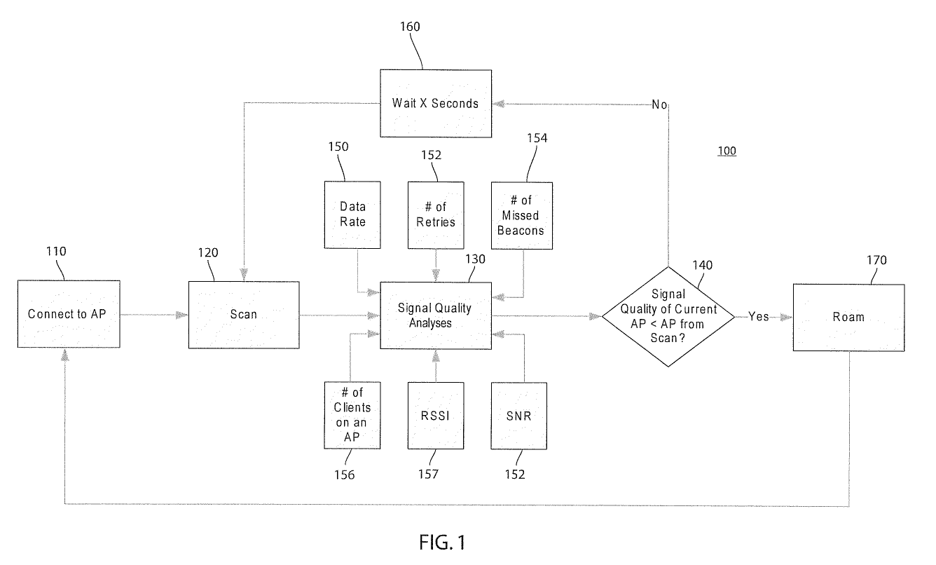

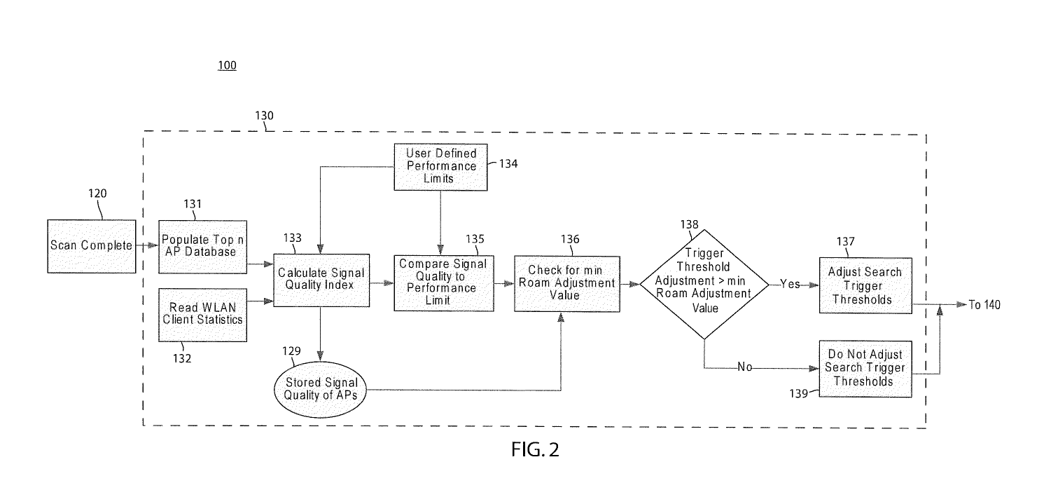

Referring back to FIG. 1, the method of the current application is illustrated. In step 110, the WLAN card 220 (FIG. 3) of the patient monitor 210 is connected to an access point 250. In step 120, the WLAN card 220 conducts a scan on the wireless system 200 to determine whether any other access points 250 have a higher quality signal than the connected access point 250 from step 110. In step 130, a signal quality analysis is conducted on the signals detected during the scan in step 120. The signal quality analysis in step 130 takes into account parameters such as received signal strength indicator (RSSI) 157, the signal to noise ratio (SNR) 158 of the access point signal, the number of clients on any particular access point 156 detected during the scan step 120, the data rate 150 of the AP 250, the number of retries in a given time period 152 of the AP 250, and the number of missed beacons 154 in a given time period. The algorithm utilized in step 130 will be discussed in greater detail below and described in FIG. 2. It should also be noted that further embodiments of the system 200 and method 100 of the present application may include any combination of the aforementioned parameters.

Still referring to FIG. 1 and FIG. 3 simultaneously, in step 140, if the calculated signal quality from step 130 from the access point (AP) 250 from the scanning step 120 is greater than that of the current signal quality of the first AP 250, then in step 170 the WLAN card 230 goes into a roaming mode, and connects to the AP 250 from the scanning step 120. If the signal quality of the current AP 250 is greater than the AP 250 from the scanning step 120, then the system 200 waits a predetermined amount of time in step 160, and returns to the scanning step 120.

Referring now to FIG. 2, the signal quality analysis step 130 of the method 100 of the present application is further described in greater detail, illustrating the algorithm associated with the signal quality analysis step 130. After the scan is completed in step 120, a signal quality analysis step 130 is performed. In step 131, information gathered on the Top n APs (e.g. n could be 8 or 12, or what is most optimal for the current system 200) that the WLAN Client is not connected to, but are in close proximity to the WLAN Client, is stored in the memory of the WLAN card 220 and entered into the Signal Quality algorithm. This information may include Signal Strength, number of clients connected to a given AP, or similar statistics related to Radio Frequency (RF) or network performance. In step 132, information gathered on the WLAN Client Statistics specific to the current state of the link quality (e.g. RSSI, SNR, Noise Floor, Data Rate, etc.) of the AP that the WLAN Client is connected to, is stored in the memory and fed into the Signal Quality algorithm.

In step 133, the information collected from steps 131 and 132 are then used to calculate an overall Signal Quality for each AP. The Signal Quality values of each AP are then stored for use in step 137. The User Defined Performance Parameters establish the limits and are weighted according to their importance. In step 134, user-defined performance limits are established. For example, depending on the application of the WLAN Client, the user may want it to be more sensitive to interference, client loading, and/or signal strength. In step 135, the signal quality index of step 133 and user-defined performance limits 134 are compared to determine how much the environment has changed. A subset of the Top n APs (e.g. subset could be 3 or 8, or what is most optimal for the system) in the list are compared to the currently connected AP.

In steps 136 and 138, in order to avoid changing the threshold for minute changes in the wireless environment, a comparison is done between the current and previous Threshold values as well as the min Roam adjustment value. If the difference between the current and previous Threshold values for each AP is less than the min Roam adjustment value, a new threshold is not set. If greater, a new value is set. In steps 137 and 139, the lowest Signal Quality of the subset would establish the new trigger threshold.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A wireless patient monitoring system, the system comprising:
a plurality of wireless access points dispersed throughout a monitoring area wherein the plurality of access points are connected together through a network; and
a patient monitor including a WLAN wireless card, wherein the WLAN wireless card wirelessly connects the patient monitor to a first wireless access point of the plurality of wireless access points,
wherein the WLAN wireless card scans the monitoring area and performs a signal quality analyses on the plurality of access points, and further wherein the WLAN wireless card goes into a roam mode when a signal quality of the first wireless access point is less than the signal quality of any of the analyzed plurality of access points.

2. The system of claim 1, wherein when the WLAN wireless card goes into the roam mode, the WLAN wireless card connects to a second wireless access point having a highest signal quality.

3. The system of claim 2, wherein the WLAN wireless card waits a predetermined amount of time before conducting a second scan of the plurality of access points when the signal quality of the first wireless access point is greater than the signal quality of the analyzed plurality of access points.

4. The system of claim 1, wherein the WLAN wireless card includes a processor and a storage medium, wherein the processor executes a set of executable code stored in a storage medium, thus effectuating the operation of the WLAN wireless card.

5. The system of claim 1, wherein the signal quality and analyses includes calculating a signal quality index and comparing the signal quality index to a user defined performance limit.

6. The system of claim 5, wherein the signal quality analyses further includes comparing a difference between a current threshold value and a previous threshold value with a minimum roam adjustment value and adjusting a set of search trigger thresholds when the difference is greater than the minimum roam adjustment.

7. The system of claim 5, wherein calculating the signal quality index utilizes a number of parameters, including:
a received signal strength indicator (RSSI);
a signal to noise ration (SNR) of the access point signal;
a number of clients on any particular access point detected during the scan step;
a data rate of the AP;
a number of retries in a given time period of the AP; and
a number of missed beacons in a given time period.

8. The system of claim 1, wherein the WLAN card is an original equipment manufacturer device.

9. A method of adaptive roaming in a wireless patient monitoring system, the method comprising:
executing a set of executable code stored in a storage medium with a processor, thus effectuating the following steps:
wirelessly connecting a patient monitor with a WLAN wireless card to a first wireless access point of a plurality of wireless access points dispersed throughout a monitoring area, wherein the plurality of access points are connected together through a network;
scanning with the WLAN wireless card the monitoring area;
performing a signal quality analyses on the plurality of access points; and
entering a roam mode with the WLAN wireless card when a signal quality of the first wireless access point is less than the signal quality of any of the analyzed plurality of access points.

10. The method of claim 9, further comprising the WLAN wireless card connecting to a second wireless access point having a highest signal quality when the WLAN wireless card enters the roam mode.

11. The method of claim 10, further comprising the WLAN wireless card waiting a predetermined amount of time before conducting a second scanning of the plurality of access points when the signal quality of the first wireless access point is greater than the signal quality of the analyzed plurality of access points.

12. The method of claim 9, wherein the signal quality analyses comprises calculating a signal quality index and comparing the signal quality index to a user defined performance limit.

13. The method of claim 12, wherein the signal quality analyses further comprises comparing a difference between a current threshold value and a previous threshold value with a minimum roam adjustment value and adjusting a set of search trigger thresholds when the difference is greater than the minimum roam adjustment.

14. The method of claim 12, wherein calculating the signal quality index utilizes a number of parameters, including:
a received signal strength indicator (RSSI);
a signal to noise ration (SNR) of the access point signal;
a number of clients on any particular access point detected during the scan step;
a data rate of the AP;
a number of retries in a given time period of the AP; and
a number of missed beacons in a given time period.

15. The method of claim 9, wherein the WLAN card is an original equipment manufacturer device.

16. A wireless patient monitoring system, the system comprising:
a plurality of wireless access points dispersed throughout a monitoring area, wherein the plurality of access points are connected together through a network; and
a patient monitor, wherein the patient monitor wirelessly connects to a first wireless access point of the plurality of wireless access points,
wherein the patient monitor scans the monitoring area and performs a signal quality analyses on the plurality of access points, and further wherein the patient monitor goes into a roam mode when a signal quality of the first wireless access point is less than the signal quality of any of the analyzed plurality of access points; and
wherein when the patient monitor goes into the roam mode, the patient monitor connects to a second wireless access point having a highest signal quality.

17. The system of claim 16, wherein the patient monitor waits a predetermined amount of time before conducting a second scan of the plurality of access points when the signal quality of the first wireless access point is greater than the signal quality of the analyzed plurality of access points.

18. The system of claim 16, wherein the patient monitor includes a processor and a storage medium, wherein the processor executes a set of executable code stored in a storage medium, thus effectuating the operation of the patient monitor.

19. The system of claim 16, wherein the signal quality and analyses includes calculating a signal quality index and comparing the signal quality index to a user defined performance limit.

20. The system of claim 19, wherein the signal quality analyses further includes comparing a difference between a current threshold value and a previous threshold value with a minimum roam adjustment value and adjusting a set of search trigger thresholds when the difference is greater than the minimum roam adjustment.
